(19) United States
(12) Patent Application Publication
(10) Pub. No.: US 2008/0136385 A1
(43) Pub. Date: Jun. 12, 2008

(54) POWER TRANSMISSION SYSTEM

(75) Inventors: Chih-tao Hsieh, Sijhih City (TW); Fu-Chih Shen, Sijhih (TW); Kuan-Lun Chzu, Sijhih City (TW)

Correspondence Address: MADSON & AUSTIN, 15 WEST SOUTH TEMPLE, SUITE 900, SALT LAKE CITY, UT, 84101, US

(73) Assignee: Aten International Co., Ltd., Shijr City (TW)

(21) Appl. No.: 11/608,530

(22) Filed: Dec. 8, 2006

(51) Int. Cl. G05F 1/625

(52) U.S. Cl. 323/273; 323/282

(57) ABSTRACT

A power transmission system is described. The power transmission system comprises a local power converter, a dedicated power transmission cable and a regulating unit. The power transmission system couples the local power converter to the KVM circuit of the remote KVM device via the dedicated power transmission cable and the regulating unit. The local power converter converts a first power signal into a second power signal. The dedicated power transmission cable has a first end and a second end. The remote regulating unit is able to regulate the second power signal to generate a third power signal. The first end of the dedicated power transmission cable is coupled to the power converter for receiving the second power signal from the local power converter. The second end of the dedicated power transmission cable is coupled to the remote regulating unit for supplying the regulated second power signal to the remote KVM device.

### FIELD OF THE INVENTION

The present invention relates to a signal transmission system, and more particularly to a power transmission system comprising a plurality of twisted conducting wires for transmitting a power signal, which is suitable for a KVM device.

### BACKGROUND OF THE INVENTION

A keyboard-video-mouse (KVM) device has been developed as an important solution for the management of a plurality of computers. Conventionally, a power cord is connected between a power source and the KVM device to supply the power for driving the KVM device. Sometimes there is no power source near the KVM device, and therefore additional efforts have to be made to install a power outlet somewhere near the KVM device.

A method for supplying power signal and data signal to a networking hardware is called Power Over Ethernet (abbreviated as POE). The manner of POE is that both electrical current signal and data signal are transmitted into the networking hardware over the Ethernet Category 5. No extra alternating current (AC) power cord is needed near the networking hardware.

Furthermore, TW Patent No. 567697, entitled “Long distance transmission system and related apparatus thereof” discloses a network system for high-speed and long distance transmission over a kind of cable. TW Patent No. 578975, entitled “A network hardware for supplying power to a network terminal device” discloses one kind of cable transmits the power signal into the network. The cable adopted by the above-mentioned patents is the Category 5 data cable consisting of four pair of twisted conducting wires, wherein two pairs of conducting wires are used to transmit data signal, and another two pairs of conducting wires are used to transmit power signal.

### SUMMARY OF THE INVENTION

One object of the present invention is to provide a power transmission system to extend the transmission distance of the power signal.

Another object of the present invention is to provide a power transmission system to increase the transmission stability of the power signal such that a KVM device operates properly.

The power transmission system comprises a local power converter, a dedicated power transmission cable and a regulating unit. The power transmission system couples the local power converter to the KVM circuit of the remote KVM device via the dedicated power transmission cable and the regulating unit. The local power converter converts a first power signal into a second power signal. A power source provides the local power converter with the first power signal. The dedicated power transmission cable has a first end and a second end. The remote regulating unit is able to regulate the second power signal to generate a third power signal.

The first end of the dedicated power transmission cable is coupled to the power converter for receiving the second power signal from the local power converter. The second end of the dedicated power transmission cable is coupled to the remote regulating unit for supplying the regulated second power signal to the remote KVM device. For example, the KVM device may be a KVM switch, a KVM console module, a KVM extender or a video extender.

In one preferred embodiment of the present invention, the dedicated power transmission cable comprises a plurality of twisted pair conducting wires and the dedicated power transmission cable comprises CAT series cables including a category 5 cable, a category 5e cable and a category 6 cable. Preferably, two conducting wires are twisted around each other to minimize interference from other twisted pair conducting wires in the cable. The twisted pairs of conducting wires within the cable are available unshielded twisted pairs (UTPs) or shielded twisted pairs (STPs). STP is used in noisy environments where the shield around each of the conducting wire pairs, plus an overall shield, protects against excessive electromagnetic interference. The remote regulating unit is a linear regulator or a switching regulator. The remote regulating unit is disposed within or outside the remote KVM device.

In the present invention, the dedicated power transmission cable is quite available. When the dedicated power transmission cable of the power transmission system is connected to the power source which is far from the KVM device based on the availability of power source, the transmission distance of the power signal is conveniently extended to the installation site of the power source and is not limited by the length of the power transmission cable.

The first end of the dedicated power transmission cable comprises an RJ-45 connector and the local power converter comprises an RJ-45 jack. The first end of the dedicated power transmission cable can be conveniently connected to the local power converter by inserting the RJ-45 connector of the first end into the RJ-45 jack of the local power converter. On the other hand, the second end of the dedicated power transmission cable comprises an RJ-45 connector and the remote regulating unit comprises an RJ-45 jack. The second end is easily connected to the remote regulating unit by inserting the RJ-45 connector of the second into the RJ-45 jack of the remote regulating unit.

In one embodiment, the first power signal which is inputted into the local power converter is an alternating current (AC) signal. The amplitude of the AC signal is preferably between 100 volts and 240 volts or arbitrary range of voltages. The second power signal transmitted by the dedicated power transmission cable is a direct current (DC) signal. The amplitude of the second voltage signal is preferably between 24 and 48 volts. Part of the first and second ends of the conducting wires is combined as a positive electrode and the rest of the conducting wires are combined as a negative electrode having a potential level in comparison with the positive electrode. Thus, the transmission of the power signal is distributed to the twisted pair conducting wires when the power signal passes through the positive electrode and negative electrode, e.g. ground terminal. In other words, the power signal is equally transmitted by these conducting wires.

The advantages of the present invention include: (a) extending the transmission distance of the power signal; and (b) increase the transmission stability of the power signal.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of a power transmission system comprising a dedicated power cable according to one embodiment of the present invention.

FIG. 2 is a schematic diagram of the dedicated power cable shown in FIG. 1 according to one embodiment of the present invention.

FIG. 3A is a schematic diagram of a linear regulator shown in FIG. 1 according to one embodiment of the present invention.

FIG. 3B is a schematic diagram of a switching regulator shown in FIG. 1 according to another embodiment of the present invention.

### DETAILED DESCRIPTION OF THE PREFERRED EMBODIMENTS

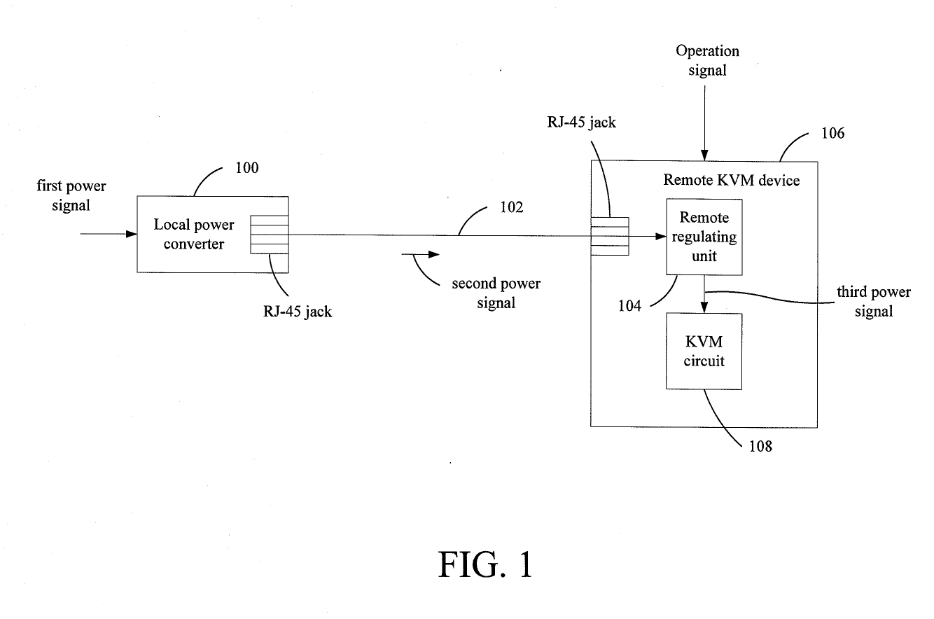

Please refer to FIG. 1. It is a schematic diagram of a power transmission system comprising a dedicated power cable according to one embodiment of the present invention. The power transmission system comprises a local power converter 100, a dedicated power transmission cable 102 and a regulating unit 104. The power transmission system couples the local power converter 100 to the KVM circuit 108 of the remote KVM device 106 via the dedicated power transmission cable 102 and the regulating unit 104.

The local power converter 100 converts a first power signal into a second power signal. A power source (not shown) provides the local power converter 100 with the first power signal. The dedicated power transmission cable 102 has a first end and a second end. The remote regulating unit 104 is able to regulate the second power signal to generate a third power signal.

The first end of the dedicated power transmission cable 102 is coupled to the power converter 100 for receiving the second power signal from the local power converter 100. The second end of the dedicated power transmission cable 102 is coupled to the remote regulating unit 104 for supplying the regulated second power signal to the remote KVM device 106. For example, the remote KVM device 106 comprises a KVM switch, KVM console module, KVM extender and video extender.

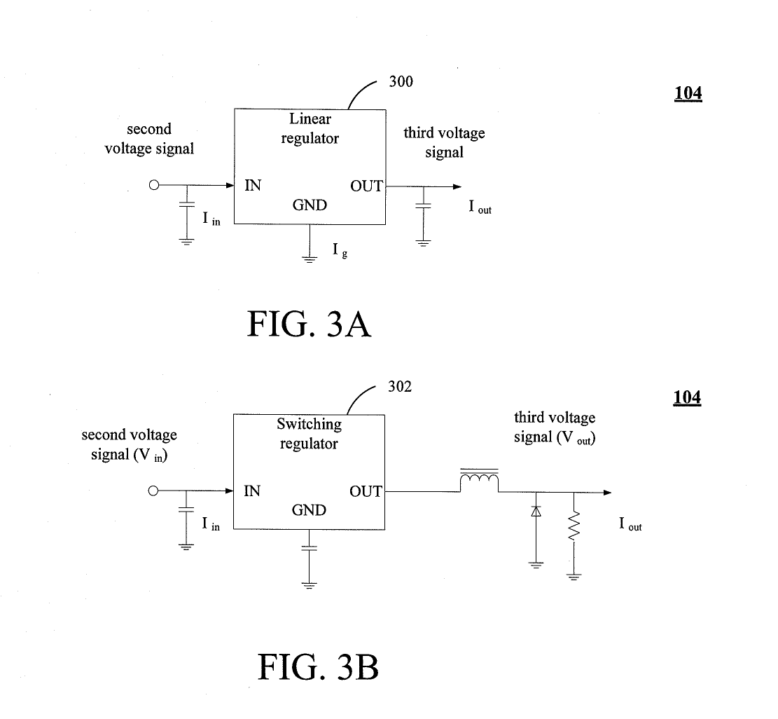

In one preferred embodiment of the present invention, the dedicated power transmission cable 102 comprises a plurality of twisted pair conducting wires and the dedicated power transmission cable 102 comprises CAT series cables including a category 5 cable, a category 5e cable and a category 6 cable. Preferably, two conducting wires are twisted around each other to minimize interference from other twisted pair conducting wires in the cable. The twisted pairs of conducting wires within the cable are available unshielded twisted pairs (UTPs) or shielded twisted pairs (STPs), with UTP being the most common. STP is used in noisy environments where the shield around each of the conducting wire pairs, plus an overall shield, protects against excessive electromagnetic interference. The remote regulating unit 104 is a linear regulator or a switching regulator. The remote regulating unit 104 is disposed within or outside the remote KVM device 106. In this case, the remote regulating unit 104 is disposed within the remote KVM device 106. The remote regulating unit 104 will be depicted in FIGS. 3A and 3B.

In the present invention, the dedicated power transmission cable 102 is quite available. When the dedicated power transmission cable 102 of the power transmission system is connected to the power source which is far from the KVM device 106 based on the availability of power source, the transmission distance of the power signal is conveniently extended to the installation site of the power source and is not limited by the length of the power transmission cable 102.

Furthermore, the power signal in the present invention is transmitted into the remote KVM device 106 by the dedicated power transmission cable 102 and an operation signal is sent to the remote KVM device 106 by another cable. That is, the power signal and the operation signal are sent to the remote KVM device 106 by two different cables, respectively. Thus, the signal interference between the power signal and operation signal within the different cables is efficiently avoided to increase the stability and reliability of the power transmission system. Persons skilled in the art should be noted that the power signal in the present invention includes a kind of voltage or current signal.

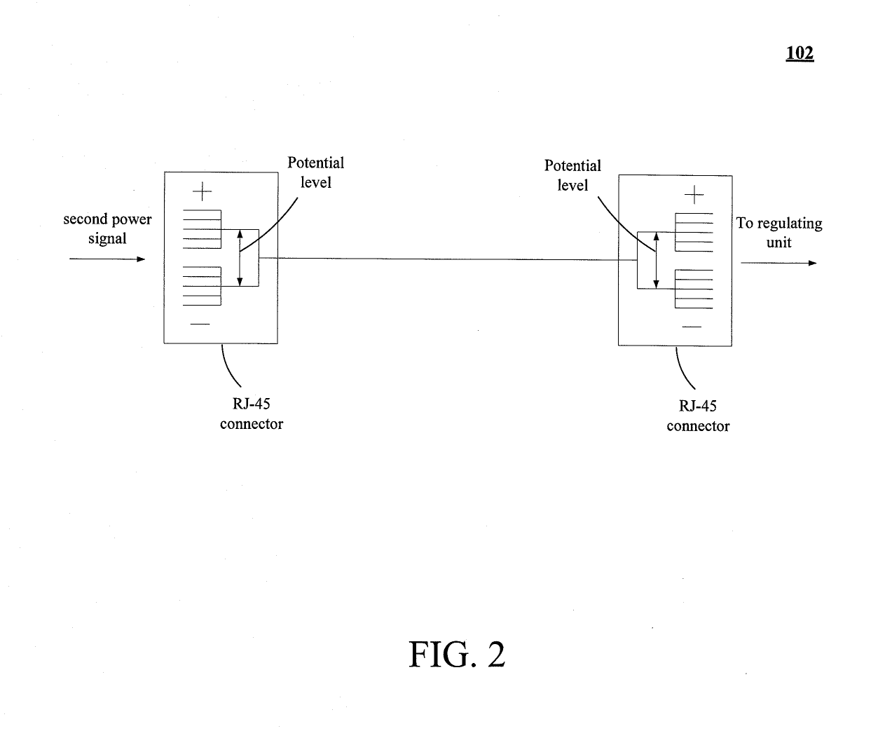

Please refer to FIG. 1 and FIG. 2. FIG. 2 shows a schematic diagram of the dedicated power cable shown in FIG. 1 according to one embodiment of the present invention. The first end of the dedicated power transmission cable 102 comprises an RJ-45 connector and the local power converter 100 comprises an RJ-45 jack. The first end of the dedicated power transmission cable 102 can be conveniently connected to the local power converter 100 by inserting the RJ-45 connector of the first end into the RJ-45 jack of the local power converter 100. On the other hand, the second end of the dedicated power transmission cable 102 comprises an RJ-45 connector and the remote regulating unit 104 comprises an RJ-45 jack. The second end is easily connected to the remote regulating unit 104 by inserting the RJ-45 connector of the second into the RJ-45 jack of the remote regulating unit 104.

In one embodiment, the first power signal which is inputted into the local power converter 100 is an alternating current (AC) signal. The amplitude of the AC signal is preferably between approximately 100 volts and 240 volts or arbitrary range of voltages. The second power signal transmitted by the dedicated power transmission cable 102 is a direct current (DC) signal. The amplitude of the second voltage signal is preferably between approximately 24 and 48 volts. Part of the first and second ends of the conducting wires is combined as a first electrode, e.g. positive electrode, and the rest of the conducting wires are combined as a second electrode, e.g. negative electrode or ground terminal. A potential level exists between the positive electrode and the negative electrode. Thus, the transmission of the power signal is distributed to the twisted pair conducting wires when the power signal passes through the positive electrode and negative electrode. In other words, the power signal is equally transmitted by these conducting wires. Thus, the transmission stability of the power signal is improved. Then the second voltage signal is converted to the third voltage signal. The amplitude of the third voltage signal is between 3.3 and 5 volts or arbitrary range of voltages to be supplied to the remote KVM device 106 properly.

FIG. 3A is a schematic detailed diagram of a linear regulator shown in FIG. 1 according to one embodiment of the present invention. The linear regulator 300, such as LM 7805 and MC 7805 chips, comprises a terminal “IN”, terminal “OUT” and terminal “GND”. In one embodiment, the second voltage signal is inputted into the terminal “IN” having a capacitor connected to the ground for generating input current “Iᵢₙ”. Ground current “I_{g}” flows into the terminal “GND”. When the potential voltage of the terminal “OUT” is third voltage signal, an output current “Iₒᵤₜ” which is the sum of input current “Iᵢₙ” and ground current “I_{g}” is outputted from the terminal “OUT”. The second voltage signal is linearly regulated by the linear regulator 300 to generate regulated voltage signal for the remote KVM device 106.

FIG. 3B is a schematic detailed diagram of a switching regulator shown in FIG. 1 according to another embodiment of the present invention. The switching regulator 302, such as LM 2574 chip, comprises a terminal “IN”, terminal “OUT” and terminal “GND”. In one embodiment, the second voltage signal (Vᵢₙ) is inputted into the terminal “IN” having a capacitor connected to the ground for generating input current “Iᵢₙ”. The terminal “GND” is coupled to a capacitor. When the potential voltage of the terminal “OUT” connected to a transformer, a diode, a resistor is third voltage signal (Vₒᵤₜ), an output current “Iₒᵤₜ” is outputted from the terminal “OUT”. The product of the second voltage signal (Vᵢₙ) and input current “Iᵢₙ” multiplying a coefficient value is equal to the product of third voltage signal (Vₒᵤₜ) and the output current “Iₒᵤₜ” That is, the product of input power performance and the coefficient value is equal to the output power performance. The second voltage signal is switched by the switching regulator 302 to generate the switched voltage signal for the remote KVM device 106. It should be noted that linear regulator 300 may be arbitrary kind of linear regulating chips or circuits and the switching regulator 302 may be arbitrary kind of switching regulation chips or circuits.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A power transmission system suitable for a KVM device, the power transmission system comprising:
a power converter, converting a first power signal into a second power signal;
a dedicated power transmission cable comprising a plurality of twisted pair conducting wires and having a first end and a second end; and
a regulating unit, for regulating the second power signal;
wherein the first end of the dedicated power transmission cable is coupled to the power converter for receiving the second power signal from the power converter, and the second end of the dedicated power transmission cable is coupled to the regulating unit for supplying the regulated second power signal to the KVM device.

2. The power transmission system of claim 1, wherein the first end of the dedicated power transmission cable comprises an RJ-45 connector and the power converter comprises an RJ-45 jack.

3. The power transmission system of claim 1, wherein the second end of the dedicated power transmission cable comprises an RJ-45 connector and the regulating unit comprises an RJ-45 jack.

4. The power transmission system of claim 1, wherein the regulating unit is a linear regulator or a switching regulator.

5. The power transmission system of claim 1, wherein the KVM device is selected from the group consisting a KVM switch, a KVM console module, a KVM extender and a video extender.

6. The power transmission system of claim 1, wherein the regulating unit is disposed within the KVM device.

7. The power transmission system of claim 1, wherein part of the conducting wires of the dedicated power transmission cable are combined as a first electrode and the rest of the conducting wires are combined as a second electrode.

8. The power transmission system of claim 1, wherein the dedicated power transmission cable is selected from the group consisting of a category 5 cable, a category 5e cable and a category 6 cable.

9. The power transmission system of claim 8, wherein two pairs of the conducting wires are combined as a first electrode and the other two pairs of the conducting wires are combined as a second electrode.

10. The power transmission system of claim 1, wherein the second power signal is a direct current (DC) signal.

11. The power transmission system of claim 10, wherein the first power signal is an alternating current (AC) signal with an amplitude between approximately 100 volts and 240 volts.

12. A power transmission system, comprising:
a power converter, converting a first power signal into a second power signal;
a dedicated power transmission cable comprising a plurality of twisted pair conducting wires and having a first end and a second end; and
a switching regulator, for regulating the second power signal in a switching mode;
wherein the first end of the dedicated power transmission cable is coupled to the power converter for receiving the second power signal from the power converter, and the second end of the dedicated power transmission cable is coupled to the switching regulator for supplying the regulated second power signal.

13. The power transmission system of claim 12, wherein the first end of the dedicated power transmission cable comprises an RJ-45 connector and the power converter comprises an RJ-45 jack.

14. The power transmission system of claim 12, wherein the second end of the dedicated power transmission cable comprises an RJ-45 connector and the switching regulator comprises an RJ-45 jack.

15. The power transmission system of claim 12, wherein the dedicated power transmission cable is selected from the group consisting of a category 5 cable, a category 5e cable and a category 6 cable.

16. The power transmission system of claim 12, wherein the second power signal is a direct current (DC) signal.

17. The power transmission system of claim 16, wherein the amplitude of the DC signal is between approximately 24 and 48 volts.

18. The power transmission system of claim 16, wherein part of the conducting wires are combined as a positive electrode and the rest of the conducting wires are combined as a negative electrode.

19. The power transmission system of claim 12, wherein the first power signal is an alternating current (AC) signal.

20. The power transmission system of claim 19, wherein the amplitude of the AC signal is between approximately 100 volts and 240 volts.
